(19) United States
(12) Patent Application Publication
(10) Pub. No.: US 2014/0163827 A1
(43) Pub. Date: Jun. 12, 2014

(54) SHIFT CONTROL METHOD AND SYSTEM FOR HYBRID VEHICLE

(71) Applicants: Kia Motors Corporation, Seoul (KR); Hyundai Motor Company, Seoul (KR)

(72) Inventor: Sang Joon KIM, Seoul (KR)

(73) Assignees: KIA MOTORS CORPORATION, Seoul (KR); HYUNDAI MOTOR COMPANY, Seoul (KR)

(21) Appl. No.: 13/973,674

(22) Filed: Aug. 22, 2013

(30) Foreign Application Priority Data
Dec. 7, 2012 (KR) 10-2012-0142064

(51) Int. Cl. B60W 10/11; B60W 10/06; B60W 10/02

(52) U.S. Cl. CPC B60W 10/11; B60W 10/02; B60W 10/06
USPC 701/54; 477/84

(57) ABSTRACT

A shift control method and system for a hybrid vehicle that may shorten shift-speed time and solve a problem in demand torque during shifting by performing pressure control, to perform connection synchronization control to a target shift-speed using speed control of a motor and to make at least one transmission clutch generate a driver's demand torque, while performing shift-control. The shift control method for a hybrid vehicle using power of an engine and/or power of a motor includes: controlling a pressure of at least one transmission clutch to shift to a target shift-speed; and controlling a speed of the motor for speeds at both ends of the at least one transmission clutch to be synchronized while being shifted to the target shift-speed.

### CROSS-REFERENCE TO RELATED APPLICATION

This application claims priority to and the benefit of Korean Patent Application No. 10-2012-0142064 filed in the Korean Intellectual Property Office on Dec. 7, 2012, the entire contents of which are incorporated herein by reference.

### BACKGROUND OF THE DISCLOSURE

(a) Field of the Disclosure

The present disclosure relates generally to a shift control method and system for a hybrid vehicle. More particularly, the present disclosure relates to a shift control method and system for a hybrid vehicle that may shorten shift-speed time and solve a problem in demand torque during shifting by, for example, performing pressure control to perform connection synchronization control to a target shift-speed using speed control of a motor and to make a transmission clutch generate a driver's demand torque, while performing shift control.

(b) Description of the Related Art

Hybrid electric vehicles operate using power from an internal combustion engine and power from a battery. In particular, hybrid vehicles are designed to efficiently combine and use power of the internal combustion engine and the motor.

For example, as illustrated in FIG. 1, a hybrid vehicle includes an engine 10, a motor 20, an engine clutch 30, a transmission 40, a differential gear unit 50, a battery 60, an integrated starter-generator (ISG) 70, and wheels 80. The engine clutch 30 controls power transmission between the engine 10 and the motor 20, and the integrated starter-generator (ISG) 70 starts the engine 10 or generates electric power by an output torque of the engine 10.

As also shown in FIG. 1, the hybrid vehicle further includes: a hybrid control unit (HCU) 200 which controls overall operation of the hybrid electric vehicle; an engine control unit (ECU) 110 which controls operation of the engine 10; a motor control unit (MCU) 120 which controls operation of the motor 20; a transmission control unit (TCU) 140 which controls operation of the transmission 40; and a battery control unit (BCU) 160 which manages and controls the battery 60.

The battery control unit 160 may also be referred to as a battery management system (BMS). The integrated starter-generator 70 may also be referred to as a starting/generating motor or a hybrid starter-generator.

The hybrid vehicle may run in a driving mode such as an electric vehicle (EV) mode using only power of the motor 20, a hybrid electric vehicle (HEV) mode using torque of the engine 10 as the main power and torque of the motor 20 as auxiliary power, and a regenerative braking (RB) mode during braking or when the vehicle runs by inertia. In the RB mode, braking and inertia energy are collected through power generation of the motor 20, and the battery 60 is charged with the collected energy.

In addition, while a hybrid vehicle in which an automatic transmission or a dual clutch transmission (DCT) is installed is shifting speed, a transmission system of the hybrid vehicle feedback-controls pressure (e.g., oil pressure) for connecting an operating element (e.g., a transmission clutch) to a target shift-speed.

Further, while the hybrid vehicle in which the automatic transmission or the dual clutch transmission (DCT) is installed is shifting speed, the transmission system of the hybrid vehicle may perform auxiliary control to decrease or increase a torque of transmission input elements (e.g., an engine and a motor).

However, as described above, when slip-control of the transmission clutch is performed by feedback-control of the pressure, transmission torque may vary according to the feedback-controlled pressure amount.

That is, when slip-control of the transmission clutch is performed by the feedback-control of the pressure, as evidenced by the following equation, although transmitting torque and driving torque of the transmission clutch are equal, the driving torque and the driver's demand torque are not equal.

In the following equation, T_driving is the driving torque, T_CL is the transmitting torque of the transmission torque, and T_demand is the driver's demand torque.

T_driving=T_{—}CL≠T_demand

FIG. 2 is a drawing illustrating problems occurring in association with the slip-control of transmission clutches (CL1, CL2, . . . ) performed by feedback-control of the pressure.

Referring to FIG. 2, when the first shift-speed is changed to the second shift-speed, the transmission clutches are controlled by oil pressure or by a motor. Act Stroke shown in FIG. 2 is controlled by oil pressure or by a motor. The Act Stroke is a moving distance of a clamping load working the transmission clutches.

As illustrated in FIG. 2, the Act Stroke may be controlled based on an initial point (shown as Init. Pt.), a kiss point (shown as Kiss Pt.), and a lock-up point (shown as Lock Pt.).

Shift control from the first shift-speed to the second shift-speed is controlled to change operation of a transmission clutch (CL1) for the first shift-speed to operation of a transmission clutch (CL2) for the second shift-speed. Accordingly, as illustrated in FIG. 2, while performing the shift control, the CL1 is released and the CL2 is engaged for slip-controlling. While performing the shift control, the speed of the motor decreases from an output speed of the CL1 to an output speed of the CL2.

Generally, pressure control for the CL2 is performed to synchronize the speed of the motor with the speed of the CL2, and feedback-control is performed to fit a predetermined target delta RPM to a speed for synchronizing.

In doing so, the motor is controlled to properly decrease torque to decrease the speed.

However, as described above, when feedback-control for the pressure is performed to fit delta RPM for speed synchronization of the transmission clutches, a torque (T_CL2) of the transmission clutch (CL2) for the second shift-speed is changed by the pressure. When the T_CL2 is changed, the driving torque may also be changed.

Also, when feedback-control for the pressure is performed to fit the delta RPM for speed synchronization of the transmission clutches, a driver's demand torque may not be satisfied during shifting.

Technology related to shift control for a hybrid vehicle is disclosed in Japanese publication patent number 2011-105024 and Korean publication patent number 10-2010-0017028 as examples of the related art.

The above information disclosed in this Background section is only for enhancing the understanding of the background of the disclosure and therefore it may contain information that is not prior art to the present disclosure.

### SUMMARY OF THE DISCLOSURE

The present disclosure has been made in an effort to provide a shift control method and system for a hybrid vehicle which can perform torque control for shifting through pressure control of at least one transmission clutch and perform speed control of both ends of a transmission clutch for speed synchronization through speed control of a motor.

In other words, the present disclosure has been made in an effort to provide a shift control method and system for a hybrid vehicle which can enable advantages such as shortening shift-speed time and solving a problem in demand torque during shifting. These exemplary advantages can be realized by, for example, performing pressure control to perform connection synchronization control to a target shift-speed using speed control of a motor and to make at least one transmission clutch generate a driver's demand torque, while performing shift-control.

An exemplary embodiment of the present disclosure provides a shift control method for a hybrid vehicle using power of an engine and/or power of a motor, including: controlling a pressure of at least one transmission clutch to shift to a target shift-speed; and controlling a speed of the motor for speeds at both ends of the at least one transmission clutch to be synchronized while being shifted to the target shift-speed.

The controlling a pressure of at least one transmission clutch may include controlling a driving torque, a transmission torque of the at least one transmission clutch, and a driver's demand torque to be equal.

The controlling a speed of the motor may include calculating a delta RPM, which is a speed difference between an input speed of the at least one transmission clutch and an output speed of the at least one transmission clutch, and controlling the speed of the motor for the delta RPM to be 0 (zero).

The hybrid vehicle may include an automatic transmission, and the pressure of the at least one transmission clutch may be set based on a temperature of an automatic transmission fluid (ATF) in the automatic transmission.

The hybrid vehicle may include a dual clutch transmission (DCT), and the pressure of the at least one transmission clutch may be set based on a coolant temperature.

Another exemplary embodiment of the present disclosure provides a shift control system for a hybrid vehicle running by using power of an engine and/or power of a motor, including: at least one transmission clutch configured to engage or disengage a power shaft with a driving shaft to shift to a corresponding shift-speed, wherein the at least one transmission clutch is installed in a transmission; and a control unit configured to perform synchronization control for connection to a target shift-speed using speed control of the motor while shifting and to make the at least one transmission clutch generate driver's demand torque using pressure control,

wherein the control unit is operated by a predetermined program, and the predetermined program includes a series of commands for executing a shift control method for a hybrid vehicle, including: controlling a pressure of the at least one transmission clutch to shift to a target shift-speed; and controlling a speed of the motor for speeds at both ends of the at least one transmission clutch to be synchronized while being shifted to the target shift-speed.

The control unit may include: a delta RPM calculating unit configured to calculate a delta RPM corresponding to a speed difference between a speed of the motor and an output speed of the at least one transmission clutch; a PID (proportional integral differential) control unit configured to perform a PID control for the shift control based on the delta RPM calculated by the delta RPM calculating unit; and a motor torque command unit configured to output a motor torque command signal to control the motor based on a driver's demand torque and a signal from the PID control unit that are feed-forwardly inputted to the motor torque command unit.

As described above, according to exemplary embodiments of the present disclosure, it may be possible to shorten shift-speed time and solve a problem in demand torque during shifting by performing pressure control, to perform connection synchronization control to a target shift-speed using speed control of a motor and to make at least one transmission clutch generate a driver's demand torque, while performing shift-speed.

### BRIEF DESCRIPTION OF THE DRAWINGS

FIG. 1 is an exemplary block diagram illustrating a configuration of an example hybrid vehicle.

FIG. 2 is an exemplary graph illustrating a shift operation for a hybrid vehicle according to an exemplary embodiment of related art.

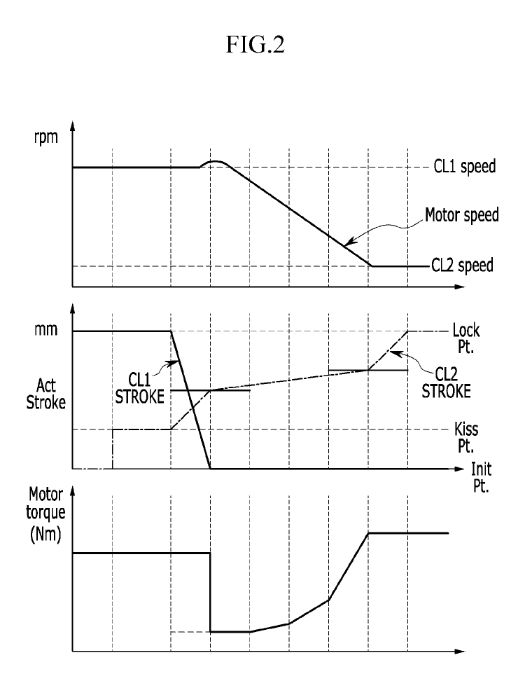

FIG. 3 illustrates an exemplary configuration of a shift control system for a hybrid vehicle according to an exemplary embodiment of the present disclosure.

FIG. 4 illustrates an exemplary configuration of a speed shift control unit according to an exemplary embodiment of the present disclosure.

FIG. 5 is an exemplary flowchart of a shift control method for a hybrid vehicle according to an exemplary embodiment of the present disclosure.

FIG. 6 is a shift operation graph according to an exemplary embodiment of the present disclosure.

### DETAILED DESCRIPTION OF EXEMPLARY EMBODIMENTS

Hereinafter, the present disclosure will be described more fully with reference to the accompanying drawings, in which exemplary embodiments of the disclosure are shown. As those having ordinary skill in the art would realize, the described exemplary embodiments may be modified in various different ways, all without departing from the spirit or scope of the present disclosure.

Further, throughout the specification, like reference numerals refer to like elements.

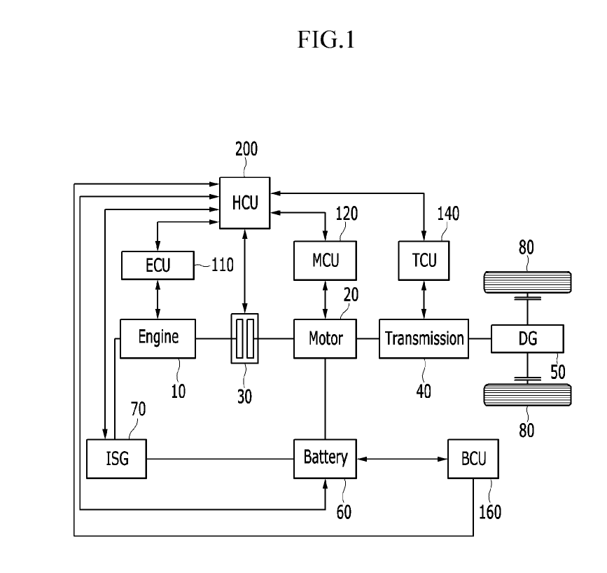

FIG. 1 is a diagram illustrating an example hybrid vehicle to which a shift control system according to an exemplary embodiment of the present disclosure may be applied.

As shown in FIG. 1, an example hybrid vehicle may generally include an engine 10, a motor 20, an engine clutch 30, a transmission 40, a differential gear unit 50, a battery 60, and an integrated starter-generator 70. The engine clutch 30 controls power transmission between the engine 10 and the motor 20, and the integrated starter-generator 70 starts the engine 10 or generates electric power by an output of the engine 10.

The hybrid vehicle to which the shift control system according to an exemplary embodiment of the present disclosure can be applied may further include a hybrid control unit (HCU) 200 configured to control an overall operation of the hybrid electric vehicle, an engine control unit (ECU) 110 configured to control an operation of the engine 10, a motor control unit (MCU) 120 configured to control an operation of the motor 20, a transmission control unit (TCU) 140 configured to control an operation of the transmission 40, and a battery control unit (BCU) 160 configured to manage and control the battery 60.

The transmission 40 of the hybrid vehicle to which the shift control system according to an exemplary embodiment of the present disclosure can be applied may be an automatic transmission (AT) or a dual clutch transmission (DCT).

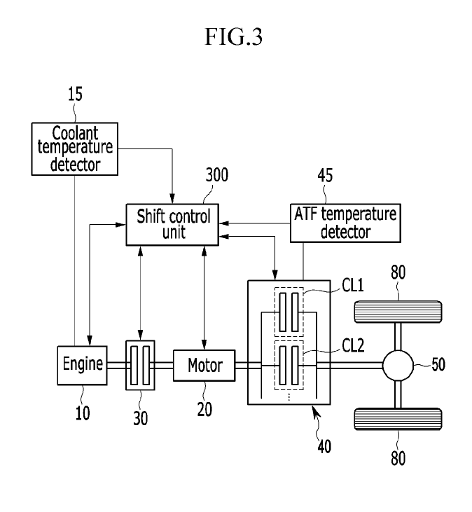

FIG. 3 illustrates an exemplary configuration of a shift control system for a hybrid vehicle according to an exemplary embodiment of the present disclosure.

The shift control system for the hybrid vehicle according to an exemplary embodiment of the present disclosure is a system that can perform torque control for shifting through pressure control of transmission clutches (CL1, CL2, . . . ) and can perform speed control of both ends of the transmission clutches (CL1, CL2, . . . ) for speed synchronization through speed control of a motor 20.

The shift control system for the hybrid vehicle according to an exemplary embodiment of the present disclosure may include: transmission clutches (CL1, CL2, . . . ) configured to engage or disengage a power shaft with a driving shaft to shift to a corresponding shift-speed, wherein the transmission clutches (CL1, CL2, . . . ) are installed in a transmission 40; an ATF (automotive transmission fluid) temperature detector 45 configured to detect a temperature of automatic transmission fluid; a coolant temperature detector 15 configured to detect a temperature of a coolant; and a shift control unit 300 configured to perform torque control by shifting through pressure control of at least one of the transmission clutches (CL1, CL2, . . . ) and to perform speed control of both ends of the at least one of the transmission clutches (CL1, CL2, . . . ) for speed synchronization through speed control of the motor 20.

Only the transmission clutch (CL1) for the first shift-speed and the transmission clutch (CL2) for the second shift-speed are illustrated in FIG. 3 for a simple drawing and explanation, but are not limited thereto.

The shift control unit 300 may be made up of one or more processors or microprocessors and/or hardware operated by a program including a series of commands for executing a shift control method and operating a system for a hybrid vehicle according to an exemplary embodiment of the present disclosure, which will be described below.

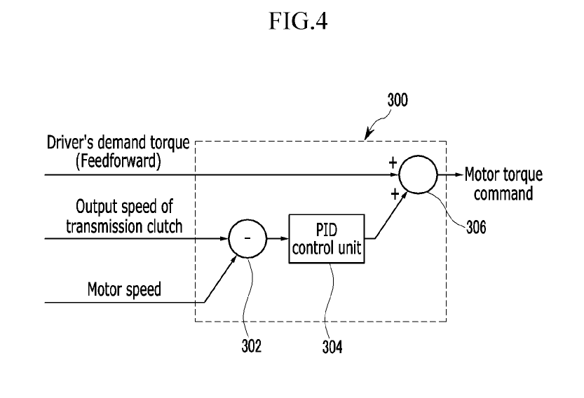

As shown in FIG. 4, the shift control unit 300 may include a delta RPM calculating unit 302 configured to calculate a delta RPM corresponding to a speed difference between a speed of the motor 20 and an output speed of the transmission clutches (CL1, CL2, . . . ); a PID (proportional integral differential) control unit 304 configured to perform a PID control for the shift control based on the delta RPM calculated by the delta RPM calculating unit 302; and a motor torque command unit 306 configured to output a motor torque command signal to control the motor 20 based on a driver's demand torque and a signal from the PID control unit 304 that are feed-forwardly inputted to the motor torque command unit 306.

In an exemplary embodiment of the present disclosure, the shift control unit 300 may include a motor control unit (MCU) configured to control operation of the motor 20, a transmission control unit (TCU) configured to control the transmission 40, and a hybrid control unit (HCU) configured to control overall operation of the hybrid electric vehicle, as illustrated in FIG. 1.

In a shift control method for a hybrid vehicle according to an exemplary embodiment of the present disclosure which will be described below, some processes may be performed by the shift control unit 300, other processes may be performed by the MCU, and yet further processes may be performed by the TCU or the HCU.

However, it should be understood that the scope of the present disclosure is not limited to the exemplary embodiment described below. The control unit may be implemented with a different combination of elements from that described in the exemplary embodiment of the present disclosure. In addition, the shift control unit 300, the MCU, the TCU, and the HCU may perform a different combination of processes from that described in the exemplary embodiment of the present disclosure.

Hereinafter, a shift control method for a hybrid vehicle according to an exemplary embodiment of the present disclosure will be described in detail with reference to the accompanying drawings.

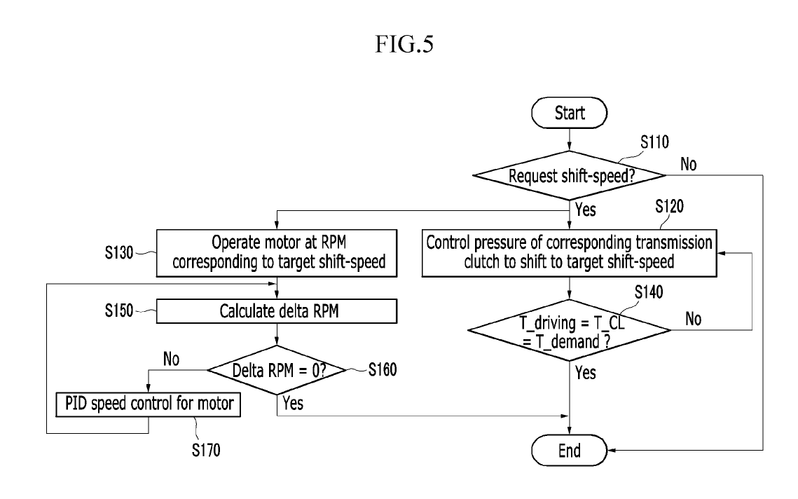

FIG. 5 is an exemplary flowchart of a shift control method for a hybrid vehicle according to an exemplary embodiment of the present disclosure.

As illustrated in FIG. 5, the shift control unit 300 determines whether shift-speed is requested while the hybrid vehicle is running at step S110.

The shift control unit 300 may determine whether a shift-speed change is requested based on a signal from the TCU 140.

The shift control unit 300 may also determine whether a shift-speed change is requested according to a shift-speed request determination process that has been generally implemented in the related art.

When the shift-speed change is requested at step S110, the shift control unit 300 controls pressure of a corresponding transmission clutch to shift to a target shift-speed at step S120.

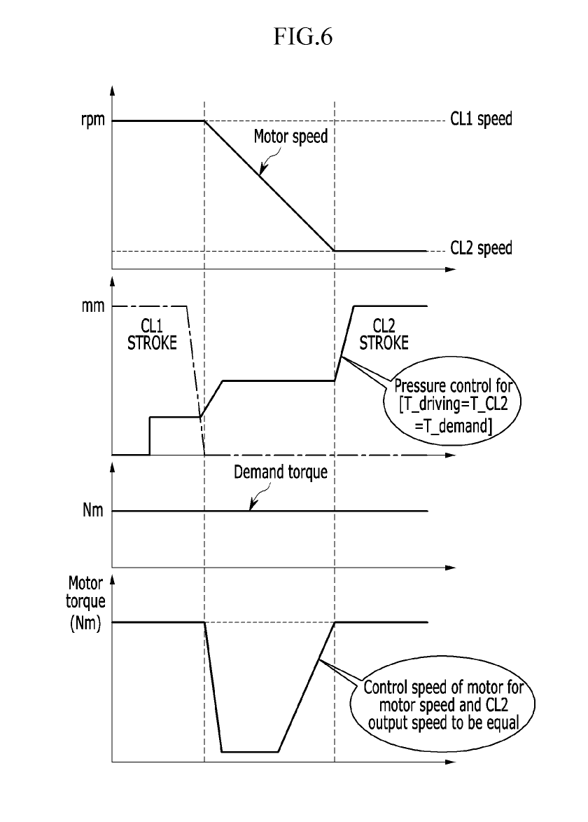

For example, according to a driver's acceleration intention, when it is requested to shift from a first shift-speed to a second shift-speed, the shift control unit 300 releases the pressure of the transmission clutch (CL1) and supplies pressure to the transmission clutch (CL2) in order to shift to the second shift-speed as a target shift-speed, as illustrated in FIG. 6.

Hereinafter, an upshifting case of shifting from the first shift-speed to the second shift-speed will be described as an example of the exemplary embodiment of the present disclosure.

The shift control unit 300 increases the pressure supplied to the transmission clutch (CL2) as illustrated in FIG. 6, and thereby equalizes driving torque (T_driving), transmission torque (T_CL2) transmitted by the transmission clutch (CL2) and driver's demand torque (T_demand) at step S140.

In other words, the shift control unit 300 compares the driving torque (T_driving), the transmission torque (T_CL2) transmitted by the transmission clutch (CL2) and the driver's demand torque (T_demand) with one another, and controls the pressure supplied to the transmission clutch (CL2), thereby equalizing the driving torque (T_driving), the transmission torque (T_CL2) transmitted by the transmission clutch (CL2), and the driver's demand torque (T_demand).

The shift control unit 300 may use the temperature detected by an ATF temperature detector 45 when controlling the pressure of transmission clutches (CL1, CL2, . . . ).

For example, if an automatic transmission is installed in the hybrid vehicle, when the shift control unit 300 controls the pressure of the transmission clutch (CL2), the shift control unit 300 may set the pressure supplied to the transmission clutch (CL2) by referring to the automatic transmission fluid (ATF) temperature of the automatic transmission, because the pressure may be influenced by the ATF temperature.

The shift control unit 300 may also use the temperature detected by a coolant temperature detector 15 when controlling pressure of the transmission clutches (CL1, CL2, . . . ).

For example, if a dual clutch transmission (DCT) is installed in the hybrid vehicle, when the shift control unit 300 controls the pressure of the transmission clutch (CL2), the shift control unit 300 may set the pressure supplied to the transmission clutch (CL2) by referring to the engine coolant temperature, because the pressure may be influenced by the engine coolant temperature.

Further, when the shift-speed change is requested at step S110, the shift control unit 300 controls the motor 20 at a speed corresponding to the second shift-speed as step S130 as well as performing the pressure control described above.

Then, the shift control unit 300 calculates delta RPM, that is a speed difference between the input speed and the output speed of the transmission clutch (CL2), at step 150, as shown in FIG. 6. The input speed of the transmission clutch (CL2) is equal to the speed of the motor 20.

When the delta RPM is calculated at step S150, the shift control unit 300 controls the speed of the motor 20 for the delta RPM to be 0 (zero) by using the PID control unit 304, thereby synchronizing speeds of both ends of the transmission clutch (CL2) with each other at steps S160 and S170.

Accordingly, the shift control method for the hybrid vehicle according to an exemplary embodiment of the present disclosure may shorten the shift-speed change time and solve a problem in demand torque. The present disclosure can make it possible to effect such results by performing torque control for shifting through pressure control of at least one transmission clutch, and by performing speed control of both ends of a transmission clutch for speed synchronization through speed control of a motor.

The shifting control from the first shift-speed to the second shift-speed has been described as an example of the exemplary embodiment of the present disclosure. It would be apparent to a person of ordinary skill in the art that other shifting control from one shift-speed to another shift-speed will be easily performed through the contents described above (e.g., from second shift-speed to first shift-speed, etc.).

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

<Description of Reference Numerals>

| | |
|---|---|
| 10: | Engine |
| 20: | Motor |
| 40: | Transmission |
| 300: | Control unit |
| CL1: | First shift-speed clutch |
| CL2: | Second shift-speed clutch |

What is claimed is:

1. A shift control method for a hybrid vehicle using power of an engine and/or power of a motor, comprising:
controlling a pressure of at least one transmission clutch to shift to a target shift-speed; and
controlling a speed of the motor for speeds at both ends of the at least one transmission clutch to be synchronized while being shifted to the target shift-speed.

2. The shift control method of claim 1, wherein the controlling a pressure of at least one transmission clutch comprises controlling a driving torque, a transmission torque of the at least one transmission clutch, and a driver's demand torque to be equal.

3. The shift control method of claim 1, wherein the controlling a speed of the motor comprises calculating a delta RPM, which is a speed difference between an input speed of the at least one transmission clutch and an output speed of the at least one transmission clutch, and controlling the speed of the motor for the delta RPM to be 0 (zero).

4. The shift control method of claim 2, wherein an automatic transmission is installed in the hybrid vehicle, and the pressure of the at least one transmission clutch is set based on a temperature of an automatic transmission fluid (ATF) in the automatic transmission.

5. The shift control method of claim 2, wherein a dual clutch transmission (DCT) is installed in the hybrid vehicle, and the pressure of the at least one transmission clutch is set based on a coolant temperature.

6. A shift control system for a hybrid vehicle running by using power of an engine and/or power of a motor, comprising:
at least one transmission clutch configured to engage or disengage a power shaft with a driving shaft to shift to a corresponding shift-speed, wherein the at least one transmission clutch is installed in a transmission; and
a control unit configured to perform synchronization control for connection to a target shift-speed using speed control of the motor while shifting and to make the at least one transmission clutch generate driver's demand torque using pressure control,
wherein the control unit is operated by a predetermined program, and the predetermined program includes a series of commands for executing a shift control method for a hybrid vehicle, comprising:
controlling a pressure of the at least one transmission clutch to shift to a target shift-speed; and
controlling a speed of the motor for speeds at both ends of the at least one transmission clutch to be synchronized while being shifted to the target shift-speed.

7. The shift control system of claim 6, further comprising:
an ATF (automotive transmission fluid) temperature detector configured to detect a temperature of an automatic transmission fluid; and
a coolant temperature detector configured to detect a temperature of a coolant.

8. The shift control system of claim 6, wherein
the control unit comprises:
a delta RPM calculating unit configured to calculate a delta RPM corresponding to a speed difference between a speed of the motor and an output speed of the at least one transmission clutch;
a PID (proportional integral differential) control unit configured to perform a PID control for the shift control based on the delta RPM calculated by the delta RPM calculating unit; and
a motor torque command unit configured to output a motor torque command signal to control the motor based on a driver's demand torque and a signal from the PID control unit that are feed-forwardly inputted to the motor torque command unit.

9. The shift control system of claim 6, wherein the controlling a pressure of the at least one transmission clutch comprises controlling a driving torque, a transmission torque of the at least one transmission clutch, and a driver's demand torque to be equal.

10. The shift control system of claim 6, wherein the controlling a speed of the motor comprises calculating a delta RPM, which is a speed difference between an input speed of the at least one transmission clutch and an output speed of the at least one transmission clutch, and controlling the speed of the motor for the delta RPM to be 0 (zero).

11. The shift control system of claim 7, wherein an automatic transmission is installed in the hybrid vehicle, and the pressure of the at least one transmission clutch is set based on a temperature of an automatic transmission fluid (ATF) in the automatic transmission.

12. The shift control system of claim 7, wherein a dual clutch transmission (DCT) is installed in the hybrid vehicle, and the pressure of the at least one transmission clutch is set based on a coolant temperature.
